(19) United States
(12) Patent Application Publication
(10) Pub. No.: US 2004/0029074 A1
(43) Pub. Date: Feb. 12, 2004

(54) Device for forming holes and inserting sleeves in a unit incorporated in a dental attachment part

(76) Inventor: Izidor Brajnovic, Goteborg (SE)

Correspondence Address: SWIDLER BERLIN SHEREFF FRIEDMAN, LLP, 3000 K STREET, NW, BOX IP, WASHINGTON, DC, 20007, US

(21) Appl. No.: 10/451,531

(22) PCT Filed: Dec. 27, 2001
(86) PCT No.: PCT/SE01/02899

(30) Foreign Application Priority Data
Dec. 29, 2000 (SE) 0004885-0

(51) Int. Cl. A61C 13/12

(52) U.S. Cl. 433/172; 433/167; 433/140

(57) ABSTRACT

A device is used for forming holes and inserting sleeves in a unit incorporated in a dental bridge or a template for forming holes in bone. The unit comprises a shell and, arranged in the latter, a matrix material which is viscous at least in an initial forming stage and which gives the unit resiliency properties or is resilient as a function of one or more actions. The device comprises a perforating part (7) by means of which the shell and the substance can be penetrated and can be pushed aside counter to the effect of the resiliency in order to form holes or recesses. Arranged behind or under (over) the perforating part there is a sleeve-supporting portion by means of which a sleeve (5) assumes a position in the hole or recess and exposes its outside to said pushed-aside and resilient shell and substance or agent. The perforating part and the sleeve are arranged to prevent any substantial leakage of the substance or agent during the penetration and the sleeve application.

The present invention relates to a device for forming holes and inserting sleeves in a unit incorporated in an attachment part intended for the human body, for example a dental attachment part which can consist of a dental bridge. The unit can also be incorporated in or intended for a template for forming holes in bone, for example dentine. The unit comprises a shell and, arranged in the latter, a substance or agent, for example matrix material, which is viscous in at least an initial forming stage and which gives the unit a certain resiliency property or is resilient as a function of an action on the unit.

In the production of a dental bridge, for example, the latter can be produced using a model, for example a plastic model, which is provided with fixture dummies. The model or plastic model can represent a model of a patient's jaw or jaw bone. The unit, i.e. the template or dental bridge, must be provided with laboratory spacers or bridge sleeves and can consist of carbon fiber-reinforced plastic. In an initial stage, the unit consists of a tube or shell and, placed in the latter, a carbon fiber reinforcement. A matrix material is additionally introduced, for example in the form of acrylic plastic which is injected into the shell or tube. In the production of the template or tooth replacement, the latter undergoes a desired shaping with the aid of molds, and, when the desired shape has been obtained, the matrix material is made to harden or stiffen so that the template or tooth replacement is assigned the desired shape. In connection with the production of the tooth replacement or the assembly template, a stage is included in which holes are to be formed in the soft unit and sleeves are to be applied in the holes thus formed.

In this connection, reference is made to Swedish Patent 457,691 which relates to a method for producing prosthetic structures made of composite material with a considerable fiber content. It is thus known per se to use these types of tooth replacements and assembly templates. Reference is also made to the patent application “Device for determining position” which was filed by the same Applicant on the same day as the present patent application.

Holes are to be formed and sleeves are to be inserted in connection with fixtures or fixture dummies in a patient's jaw or on a model. The problem in this connection is to obtain a distinct and precise positioning of the sleeves in question, and it must be possible for their position to be determined with great accuracy in relation to the fixture dummies or fixtures. The invention deals, inter alia, with this problem and solves the problem in question.

Since the unit at this stage comprises at least viscous material or substance, it is difficult to prevent the material or agent from running out or leaking from the unit during sleeve application. There is therefore a need for effective enclosure of the agent when the holes are being formed. The invention solves this problem too.

In this connection, there is a need to be able to carry out the application in a relatively straightforward way and at the same time to maintain the precise positioning of the sleeves in relation to the dummies or the fixtures. The invention solves this problem too.

The features which can principally be regarded as characterizing a device according to the invention are that it comprises a perforating part by means of which the shell and the substance can be penetrated and can be pushed aside counter to the effect of the abovementioned resiliency in order to form holes or recesses, and that it has a sleeve-supporting portion which is situated behind or under the perforating part and by means of which a sleeve assumes a position in the hole or recess and exposes its outside to said pushed-aside and resilient shell and the substance or agent. The invention is additionally characterized by the fact that the perforating part and the sleeve are arranged to prevent any substantial leakage of the substance or agent during the penetration and the sleeve application.

Embodiments of the inventive concept are set out in the attached dependent claims. As an example, use is made of spacers which can be cut off and a perforating tip which is screwed into the fixture dummy or equivalent. By means of the spacer, the position for the sleeve in question is determined, and, by means of the perforating tip, an effective penetration is executed. After the unit part in question has been penetrated, it is pressed further down over the sleeve which is supported by both the penetrating tip and the spacer. A pressing member with side parts which can be expanded and which cooperate with the template during the pressing-down on the penetrating part is also included.

By means of what has been proposed above, it is possible to obtain precise methods and devices for said formation of holes and insertion of sleeves in units of said type. The parts included in the invention are designed for simple and precise cooperation with the fixtures or fixture dummies in question. After the perforating, the perforating part or perforating tip can be easily removed and the casting molds in question can be applied to the template. There are also economic advantages because all subsequent work caused by leakage can be avoided.

A presently proposed embodiment of a device having the characteristic features of the invention will be described below with reference to the attached drawings, in which:

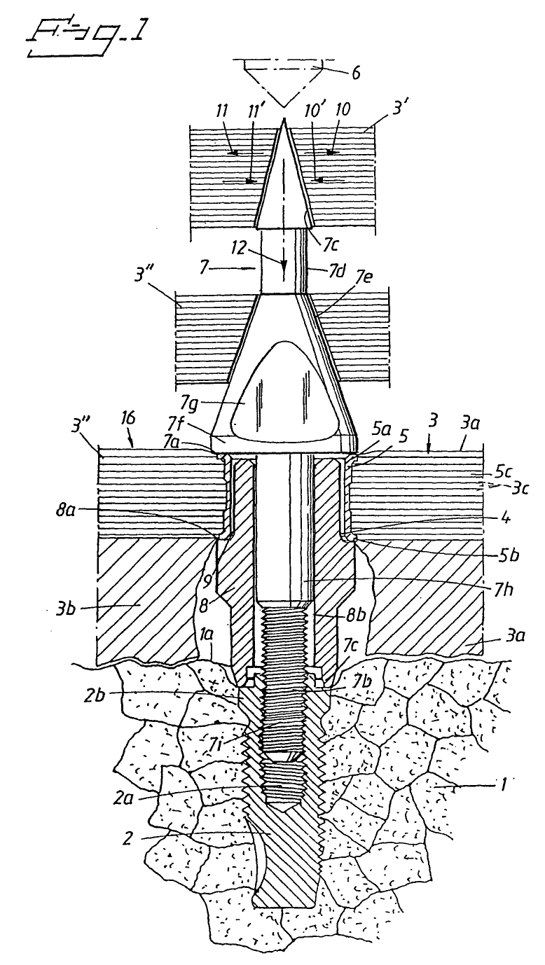

FIG. 1 is a vertical view and partial cutaway view showing the device in connection with the production of an assembly template, which production is carried out in connection with a model of the jaw bone, the assembly template being intended to be transferred to a patient's jaw bone for guiding hole-forming members (drills),

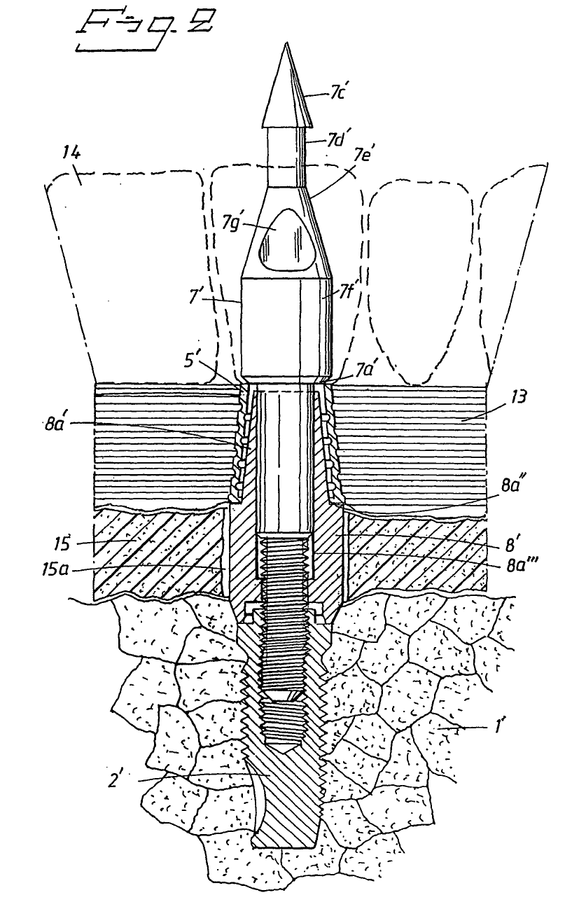

FIG. 2 is a vertical view and partial cutaway view showing the device in connection with a tooth replacement part in the form of a bridge skeleton, the bridge skeleton too being under construction on a model of a jaw bone and a model of the gum,

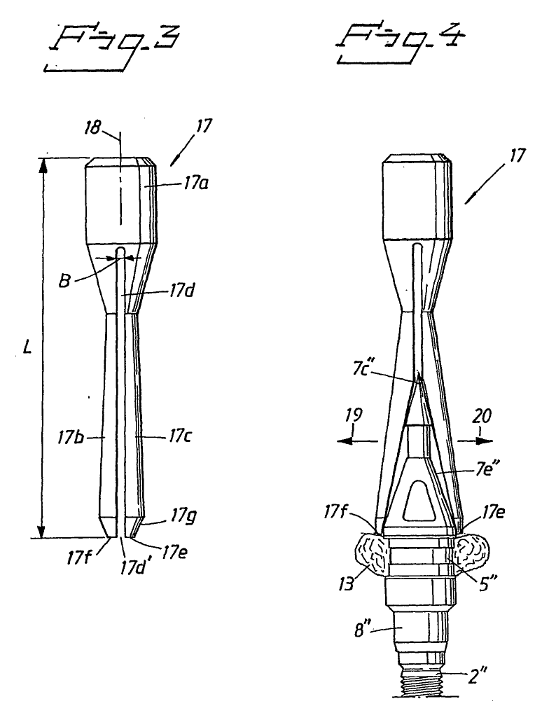

FIG. 3 is a side view showing an auxiliary application means which can be used for pressing the model (template) down over a perforating tip, and

FIG. 4 is a side view showing the pressing-down over the perforating tip.

In FIG. 1, a model of a jaw bone is indicated by 1. The model can be produced in a manner known per se, for example by means of stereolithography. A number of fixture dummies are preferably placed in the model, one fixture dummy having been indicated by 2. An assembly template for the model is to be produced and, in the illustrative embodiment, is made of or comprises carbon fiber-reinforced plastic. At this stage the assembly template has the above-described soft or yielding and to some extent resilient constitution. The template 3 must be provided with a number of recesses 4. In connection with the hole formation, sleeves 5 made of metal or alloy (e.g. titanium) are to be applied in the recesses so that a subsequent hole formation in the patient's jaw bone can be performed with the aid of the assembly template. In FIG. 1, parts of such a hole-forming member have been indicated by 6. The hole-forming member is not used in connection with the model, but instead for forming holes in the patient's jaw, but it has nonetheless been shown in the situation illustrated in FIG. 1.

The device comprises a perforating tip 7 and a spacer 8. The perforating tip is used to penetrate through the material of the template in connection with the hole formation. The spacer 8 defines the position of the sleeve 5, i.e. the position of the hole 4, in relation to the fixture 2. The perforating tip 7 and the spacer 8 form between them a space 9 in which the loose spacer is applied before the hole is formed. The perforating tip is provided with an end part 7a and the spacer with an outwardly projecting flange or shoulder 8a which extends over the end parts 5a and 5b of the sleeve. In the free position, the perforating tip and the spacer are arranged loosely in relation to one another, and the sleeve 5 is applied in such a way that it is arranged on the spacer which is then brought together with the perforating tip to the position shown in FIG. 1. The fixture 2 is provided with an internal thread 2a, and the perforating tip with an external thread, by means of which threads 2a and 7b the perforating tip can be screwed into the fixture to the position shown in FIG. 1. The upper parts 2b of the fixture dummy and the lower parts 7c of the spacer are designed for mutual cooperation in a manner known per se so that the spacer acquires a precise position on the fixture dummy. The perforating part comprises a first cone-shaped part or point 7c, which is followed by a cylindrical part 7d. The cylindrical part merges into another part 7e which is shaped as a truncated cone and which in turn merges into a straight part 7f which bears said end part 7a. A wrench holder 7g is arranged on the part shaped as a truncated cone. The perforating tip is also provided with a cylindrical guide part 7h, by means of which the tip is guided in the spacer via an inner surface 8b of the latter. The cylinder-shaped part 7h merges into a peg-shaped part 7i which bears said external thread 7b.

The hole-forming function is initiated by the perforating tip and spacer sleeve being brought together with the sleeve 5 placed in said recess. The perforating tip is screwed down in the dummy to the position shown in FIG. 1.

The actual hole-forming function proceeds with the material of the assembly template being pressed over the point 7c of the perforating tip. In FIG. 1, three different stages have been indicated by 3′, 3″ and 3′″. In the position 3′, the point 7c has penetrated through and started the hole formation, with the result that the material of the template is pressed aside substantially radially in the directions indicated by arrows 10 and 11. The penetration and pushing-aside which take place counter to a certain resiliency function mean that the cone 7c can seal against leakage of the viscous substance or material from the inside of the unit. The material or the assembly template is pressed further down in the direction indicated by 12 and, after passing the cylinder-shaped part 7d, it reaches the part 7e which is shaped as a truncated cone and which operates with the same pushing-aside function as above. The part 7e has greater dimensions than the point 7c, with the result that a wider hole is formed, i.e. the material in the bridge is pressed further outward in the substantially radial direction. This position is indicated by 3″. Said sealing function is also present in this further pressing-out. After passing the part 7e, the material or the assembly template is pressed down over the sleeve 5 to the position indicated by 3′″, where the material comes to cooperate with the outside 5c of the sleeve 5. The flange-like formations 5a and 5b contribute to sealing the material off at its hole formation surface. The perforating tip can thereafter be removed and the template can be polymerized in or by means of casting molds (not shown) which are applied over the template. The hardening or stiffening of the material can be carried out in a manner known per se. The template can also be designed with support parts 3a and 3b which cooperate with the top surface 1a of the jaw bone. Said support parts can be made of silicone applied after or in connection with the shaping of the template.

FIG. 2 shows an illustrative embodiment of a tooth replacement part in the form of a bridge skeleton 13. The tooth replacement part is intended to constitute a framework for teeth, for example made of dental acrylate, as has been shown symbolically at 14. In this case too, there is a model of the jaw bone 1′ and fixture dummies 2′ arranged in the model. The penetrating tip 7′ and the associated spacer 8′ have substantially the same structure and operate with substantially the same function as in the embodiment according to FIG. 1. Differences lie in the actual structure of the perforating tip. There is correspondingly a point 7c′, a cylindrical part 7d′ and a part 7e′ shaped as a truncated cone, but whose dimensions are smaller than the part 7e in FIG. 1. In this case, the cylindrical part 7f′ is designed with a greater length than 7f in FIG. 1. Otherwise, there are a corresponding guide part and threaded part as in the embodiment according to FIG. 1. The cooperating parts between the fixture 2′ and the spacer 8′ are also constructed in the same way. However, one difference lies in the design of the spacer 8′. The spacer is provided with a cone-shaped part 8a′ which merges into a cylindrical part 8a′″ via a shoulder 8a″. In contrast to the sleeve 5 in FIG. 1, the sleeve 5′ is in this case cone-shaped and matches the cone-shaped outer surface of the cone-shaped part 8a′. In a manner corresponding to the case according to FIG. 1, the material of the unit 13 is pressed down over the tip 7c′ and further down over the cone-shaped part 7e′ to the position shown in FIG. 2 over the cone-shaped sleeve which, before the application of the material or application of the unit, is fixed by the underside 7a′ and said shoulder 8a′. The attachment shown in the figure means that the unit 13 can be pressed down over the perforating tip and the sleeve 5′ without any substantial leakage by using the resiliency function or the elasticity of the material of the unit.

In accordance with the embodiments described above, the lower parts 7f and 7f′ have a diameter or an external dimension which slightly exceeds or is substantially identical to the upper parts of the sleeve 5 or sleeve 5′. The sleeve 5′ can be considered as being part of the above-described sealing function which confines the viscous material or substance in the unit 13. In FIG. 2, the cylinder-shaped part 8a′″ has a vertical extent so as to create a space for a model of a gum. Before the application of the perforating tip, the spacer and the sleeve 5a, the model 15 of the gum is applied and punched to form a hole 15a above the fixture 2′. The model 15 of the gum defines the position of the material in the unit or replacement part/skeleton. The material of the unit 13 is made to stiffen, e.g. after the perforating tip has been removed, with the aid of casting molds in a manner known per se. In the case according to FIG. 2 also, there is a wrench attachment 7g′ for tightening and loosening the perforating part in the fixture 2′.

In FIG. 1, the shell of the material has been symbolized by 3a, the carbon fiber reinforcement by 3b, and the matrix material or agent by 3c. The resiliency function is also shown or symbolized by 10′ and 11′. A function acting on the unit is also symbolized by 16.

FIG. 3 shows an actuating member 17 which can cooperate with the above-described template material, e.g. 3. The pressing member has a base part 17a and, connected to this, parts 17b and 17c which can be expanded or can be pressed out sideways. The member 17 can be a unit made of metal, alloy, plastic, etc. Said parts 17b and 17c which can be pressed out sideways have been obtained by means of a slit 17d which extends along the longitudinal axis 18 of the member 17. The slit extends along a length which exceeds half the length or height L of the member 17. Said parts 17b and 17c have free end surfaces 17e and 17f which are arranged on a cone-shaped part 17g. When the template material 13 is pressed down into the different positions 3′, 3″ and 3′″ over the tip 7c″ of the perforating part, the cone-shaped tip presses out in substantially radial directions 19, 20 as the template material 13 is pressed down. At the start of the pressing-down, the slit on the part 7c″ ascends the opening 17d′ in the slit 17d (see FIG. 3). In the position shown in FIG. 4, the template material has been pressed down so that it assumes, for example, the position according to FIG. 1, i.e. the position where the sleeve 5″ assumes its final position in the template material 13. Said end surfaces 17f and 17e are in this case made plane so that the cooperation with the template material 13 is extensive and the shell of the template material (see 3a above) is not damaged or penetrated by the side parts 17b and 17c in question. When the pressing member is acted upon upward in FIG. 4, the side parts 17b and 17c return to the position shown in FIG. 3. In one embodiment, the slit 17d can be made with the same width B, with the result that the pressing-out in the radial directions 19 and 20 takes place as a function of the penetration of the cone in the slit, i.e. the longer the penetration, the more the side parts 17b and 17c are acted upon in the directions 19 and 20, and vice versa. The parts 17b and 17c can also cooperate with the cone 17e″ (cf. the cone 17e in FIG. 1). The part 8 in FIG. 1 corresponds to 8″ in FIG. 4, and the implant 2 in FIG. 1 corresponds to 2′″ in FIG. 4.

The design with a cone-shaped tip which merges into a cylindrical part affords the advantage that the unit cannot slide back during hole formation, being prevented from doing so by the rear flange of the cone.

The invention is not limited to the embodiment described above by way of example, and instead it can be modified within the scope of the attached patent claims and the inventive concept.

1. A device for forming holes and inserting sleeves in a unit (3, 13) incorporated in a dental attachment part, for example a dental bridge, or a template for forming holes in bone, for example dentine, said unit comprising a shell (3a) and, arranged in the latter, a substance or agent, for example matrix material (3c), which is viscous at least in an initial forming stage and which gives the unit resiliency properties or is resilient as a function of an action (16), characterized in that it comprises a perforating part (7) by means of which the shell and the substance can be penetrated and can be pushed aside counter to the effect of the resiliency in order to form holes or recesses, in that it has a sleeve-supporting portion which is situated behind or under the perforating part and by means of which a sleeve (5) assumes a position in the hole or recess and exposes its outside to said pushed-aside and resilient shell and substance or agent, and in that the perforating part and the sleeve are arranged to prevent any substantial leakage of the substance or agent during the penetration and the sleeve application.

2. The device as claimed in patent claim 1, characterized in that the perforating part (7) and the sleeve-supporting part (8) constitute two separate parts, of which the sleeve-supporting part consists of a spacer (8′) in which the perforating part can be applied with a bearing part.

3. The device as claimed in patent claim 2, characterized in that the spacer can be applied on a fixture dummy (2) located in a model of the bone in question, for example the jaw bone.

4. The device as claimed in patent claim 2 or 3, characterized in that the bearing part of the perforating part has an external thread and extends down in a recess in the fixture dummy which comprises an internal thread (2a), in which the bearing part can be screwed via its external thread (7b), and in that the spacer cooperates with the upper part of the fixture dummy via its first end.

5. The device as claimed in patent claim 2, 3 or 4, characterized in that the perforating part and the spacer together form a space for the sleeve.

6. The device as claimed in any of the preceding patent claims, characterized in that the perforating part has a front tip (7c′) via which it attacks the unit.

7. The device as claimed in any of the preceding patent claims, characterized in that the perforating part has a substantially cylinder-shaped part (7d) which is situated under or behind the tip and which is in turn situated in front of a part shaped substantially as a truncated cone.

8. The device as claimed in any of the preceding patent claims, characterized in that the sleeve is cylindrical with outwardly projecting flanges at its ends.

9. The device as claimed in any of the preceding patent claims, characterized in that the perforating part (7) and the spacer (8) together form an external recess for the sleeve.

10. The device as claimed in any of the preceding patent claims, characterized in that the unit and the sleeve are included in the formation of a template (3) for forming holes in a patient's bone, for example jaw bone.

11. The device as claimed in any of patent claims 1-6, characterized in that the sleeve has the shape of a truncated cone (5′).

12. The device as claimed in patent claim 11, characterized in that, behind its part shaped as a truncated cone, the perforating part has another, cylindrical part.

13. The device as claimed in either of patent claims 11 and 12, characterized in that the spacer, at its part supporting the sleeve, has an external part shaped as a cone, of which the cone corresponds to the inner cone-shaped part of the sleeve.

14. The device as claimed in patent claim 11, 12 or 13, characterized in that the unit and the sleeve are included in the formation of an attachment part, for example part of a dental bridge (bridge skeleton) supporting tooth replacements.

15. The device as claimed in any of patent claims 11-14, characterized in that, under or behind its sleeve-supporting part, the spacer is situated opposite a model of the gum.

16. The device as claimed in any of patent claims 11-15, characterized in that the spacer has an external thread via which it can be screwed to the sleeve via an internal thread on the latter.

17. The device as claimed in any of patent claims 11-16, characterized in that the sleeve has an external thread by means of which it can be unscrewed from the hardened material of the unit.

18. The device as claimed in any of the preceding patent claims, characterized in that the unit also comprises carbon fiber reinforcements and thus consists of carbon fiber-reinforced plastic.

19. The device as claimed in any of the preceding patent claims, characterized in that the perforating part can cooperate with a pressing member which has a plane surface, preferably one or more end surfaces, which can cooperate with the unit (3) in connection with the unit being pressed, for example pressed down, over the perforating part, in that the pressing member is also provided with parts which can be acted upon by the perforating part and which can be acted upon substantially radially outward as the pressing increases, and in that said parts have subsidiary surfaces which form said end surface(s).

1. (currently amended) A device for forming holes and inserting sleeves in a unit (3, 13) incorporated in a dental attachment part, for example a dental bridge, or a template for forming holes in bone, for example dentine, said unit comprising a shell (3a) and, arranged in the latter, a substance or agent, for example matrix material (3c), which is viscous at least in an initial forming stage and which gives the unit resiliency properties or is resilient as a function of an action (16), characterized in that it comprises a perforating part (7) by means of which the shell and the substance can be penetrated and can be pushed aside counter to the effect of the resiliency in order to form holes or recesses, in that it has a sleeve-supporting portion which is situated behind or under the perforating part and by means of which a sleeve (5) assumes a position in the hole or recess and exposes its outside to said pushed-aside and resilient shell and substance or agent, and in that the perforating part and the sleeve are arranged to prevent any substantial leakage of the substance or agent during the penetration and the sleeve application.

2. (currently amended) The device as claimed in patent claim 1, characterized in that the perforating part (7) and the sleeve-supporting part (8) constitute two separate parts, of which the sleeve-supporting part consists of a spacer (8′) in which the perforating part can be applied with a bearing part.

3. (currently amended) The device as claimed in patent claim 2, characterized in that the spacer can be applied on a fixture dummy (2) located in a model of the bone in question, for example the jaw bone.

4. (currently amended) The device as claimed in patent claim 2 or 3, characterized in that the bearing part of the perforating part has an external thread and extends down in a recess in the fixture dummy which comprises an internal thread (2a), in which the bearing part can be screwed via its external thread (7b), and in that the spacer cooperates with the upper part of the fixture dummy via its first end.

5. (currently amended) The device as claimed in patent claim 2, 3 or 4, characterized in that the perforating part and the spacer together form a space for the sleeve.

6. (currently amended) The device as claimed in any of the preceding patent claims claim 1, characterized in that the perforating part has a front tip (7c′) via which it attacks the unit.

7. (currently amended) The device as claimed in any of the preceding patent claims claim 1, characterized in that the perforating part has a substantially cylinder-shaped part (7d) which is situated under or behind the tip and which is in turn situated in front of a part shaped substantially as a truncated cone.

8. (currently amended) The device as claimed in any of the preceding patent claims claim 1, characterized in that the sleeve is cylindrical with outwardly projecting flanges at its ends.

9. (currently amended) The device as claimed in any of the preceding patent claims claim 1, characterized in that the perforating part (7) and the spacer (8) together form an external recess for the sleeve.

10. (currently amended) The device as claimed in any of the preceding patent claims claim 1, characterized in that the unit and the sleeve are included in the formation of a template (for forming holes in a patient's bone, for example jaw bone.

11. (currently amended) The device as claimed in any of patent claims 1-6 claim 1, characterized in that the sleeve has the shape of a truncated cone 5′.

12. (original) The device as claimed in patent claim 11, characterized in that, behind its part shaped as a truncated cone, the perforating part has another, cylindrical part.

13. (currently amended) The device as claimed in either of patent claims 11 and 12 patent claim 11, characterized in that the spacer, at its part supporting the sleeve, has an external part shaped as a cone, of which the cone corresponds to the inner cone-shaped part of the sleeve.

14. (currently amended) The device as claimed in patent claim 11, 12 or 13, characterized in that the unit and the sleeve are included in the formation of an attachment part, for example part of a dental bridge (bridge skeleton) supporting tooth replacements.

15. (currently amended) The device as claimed in any of patent claims 11-14 claim 11, characterized in that, under or behind its sleeve-supporting part, the spacer is situated opposite a model of the gum.

16. (currently amended) The device as claimed in any of patent claims 11-15 claim 11, characterized in that the spacer has an external thread via which it can be screwed to the sleeve via an internal thread on the latter.

17. (currently amended) The device as claimed in any of patent claims 11-16 claim 11, characterized in that the sleeve has an external thread by means of which it can be unscrewed from the hardened material of the unit.

18. (currently amended) The device as claimed in any of the preceding patent claims patent claim 1, characterized in that the unit also comprises carbon fiber reinforcements and thus consists of carbon fiber-reinforced plastic.

19. (currently amended) The device as claimed in any of the preceding patent claims claim 1, characterized in that the perforating part can cooperate with a pressing member which has a plane surface, preferably one or more end surfaces, which can cooperate with the unit (3) in connection with the unit being pressed, for example pressed down, over the perforating part, in that the pressing member is also provided with parts which can be acted upon by the perforating part and which can be acted upon substantially radially outward as the pressing increases, and in that said parts have subsidiary surfaces which form said end surface(s).
